(19) United States
(12) Patent Application Publication
(10) Pub. No.: US 2018/0118300 A1
(43) Pub. Date: May 3, 2018

(54) BICYCLE FRONT FORK WITH GROOVES FOR RECEIVING CONTROL CABLES

(71) Applicant: Su-Ying Lin, Taichung City (TW)

(72) Inventor: Su-Ying Lin, Taichung City (TW)

(21) Appl. No.: 15/497,467

(22) Filed: Apr. 26, 2017

(30) Foreign Application Priority Data
Oct. 31, 2016 (TW) 105135231

(51) Int. Cl. B62K 21/02; B62K 21/18

(52) U.S. Cl. CPC B62K 21/02; B62J 2099/0046; B62K 21/18

(57) ABSTRACT

A bicycle front fork includes two extension tubes connected to each other at two respective top ends thereof. A steering tube is connected to a position where the two respective top ends of the two extension tubes are connected. The steering tube has at least one groove defined axially in the outer surface thereof. The at least one groove receives at least one control cable therein. The at least one control cable is hidden when the head tube is installed to the bicycle frame.

### BACKGROUND OF THE INVENTION

### 1. Fields of the Invention

The present invention relates to a bicycle front fork, and more particularly, to a bicycle front fork having grooves in which control cables are received therein. The control cables are hidden when the steering tube is inserted in the head tube.

### 2. Descriptions of Related Art

The conventional control cables such as brake cables, gear-shifting cables extend from the brake levers and gear-shifting levers, and extend along the bicycle frame, and are connected to the front wheel, the rear wheel and the sprocket unit of the gear-shifting device. That is to say, the control cables are exposed outside of the bicycle frame and easily tangled objects to cause dangerous results. Besides, the exposed control cables are easily worn out due to exposure to the sun and rain, and the control cables might even be broken.

Some manufacturers develop an arrangement that hide the control cables in the handlebar, the head tube and the frame. However, because the front fork and the head tube are rotatably connected to each other, so that the control cables extend through the wall of the head tube and then the control cables enter the head tube. In other words, there is a section of the control cables exposed outside the bicycle frame, and this affects the outer appearance of the bicycles. Another arrangement is to use a tube through which the control cables extend, and the control cables are organized and hidden. Nevertheless, the tube is an extra part for the bicycle, and the bicycle structure needs to be amended to be cooperated with the tube. The shortcomings are not well improved.

The present invention intends to provide a bicycle front fork having grooves in which control cables are received therein, such that the shortcomings mentioned above are improved.

### SUMMARY OF THE INVENTION

The present invention relates to a bicycle front fork which includes two extension tubes connected to each other at two respective top ends thereof. A steering tube is connected to a position where the two respective top ends of the two extension tubes are connected. The steering tube has at least one groove defined axially in the outer surface thereof. The at least one groove receives at least one control cable therein.

The at least one control cable is hidden when the head tube is installed to the bicycle frame. The present invention does not increase the weight of the bicycle and volume. The frame and the head tube do not need to be changed so as to save the manufacturing cost. The control cables are completely hidden and the outer appearance meets requirements of aesthetic purpose.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the bicycle front fork of the present invention;

FIG. 2 is a perspective view to show the bicycle front fork of the present invention;

FIG. 3 is a cross sectional view to show the bicycle front fork of the present invention;

FIG. 4 is an end cross sectional view of the first embodiment of the bicycle front fork of the present invention;

FIG. 5 is an end cross sectional view of the second embodiment of the bicycle front fork of the present invention;

FIG. 6 is an end cross sectional view of the third embodiment of the bicycle front fork of the present invention;

FIG. 7 is an end cross sectional view of the fourth embodiment of the bicycle front fork of the present invention;

FIG. 8 is an end cross sectional view of the fifth embodiment of the bicycle front fork of the present invention, and

FIG. 9 is an end cross sectional view of the sixth embodiment of the bicycle front fork of the present invention.

### DETAILED DESCRIPTION OF THE PREFERRED EMBODIMENT

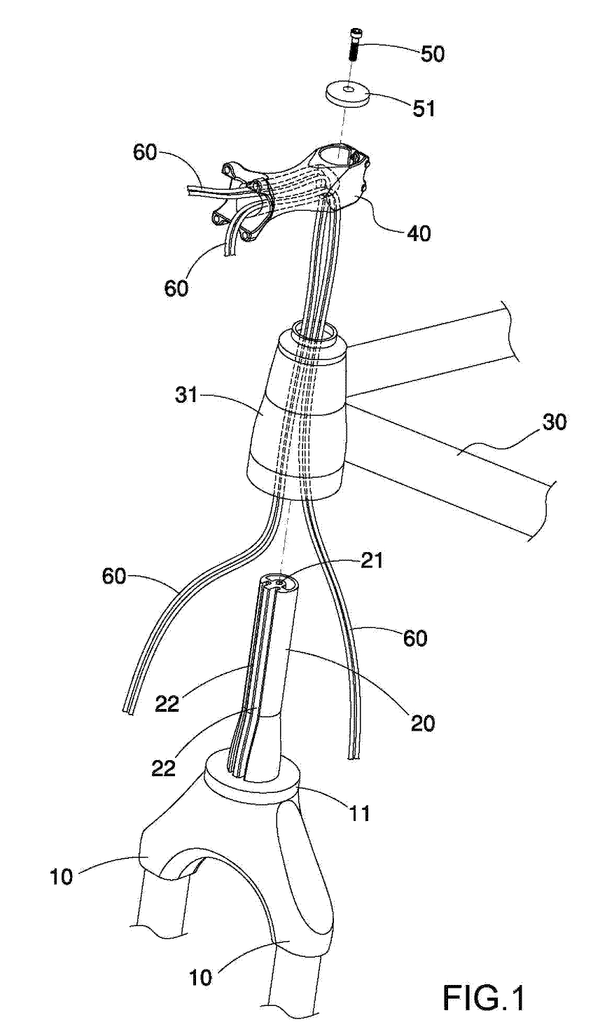

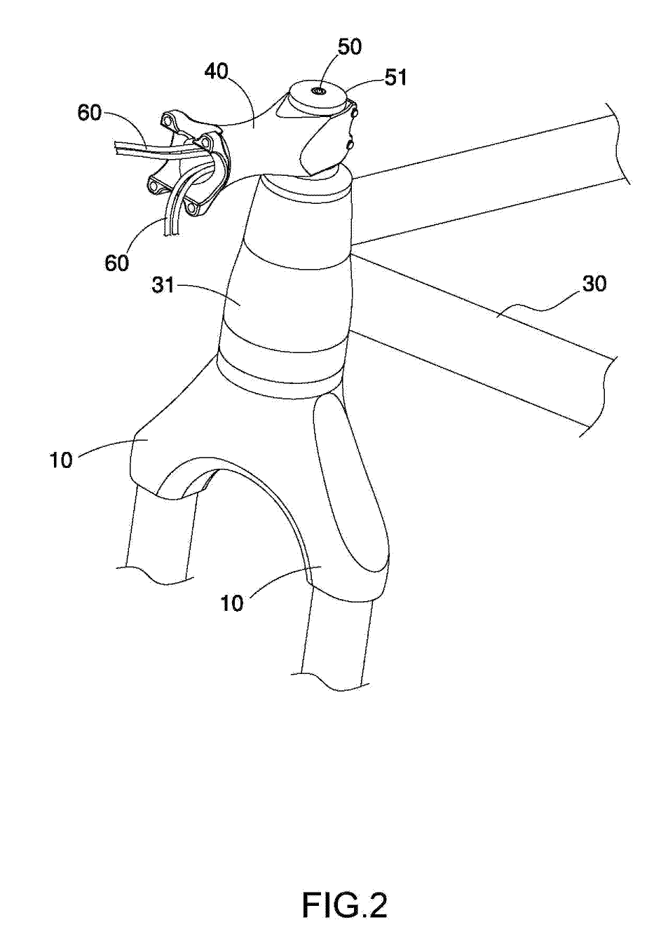

Referring to FIGS. 1 to 4, the bicycle front fork of the present invention comprises two extension tubes 10 connected to each other at two respective top ends thereof. A support 11 is formed at the position where the two respective top ends of the two extension tubes 10 are connected.

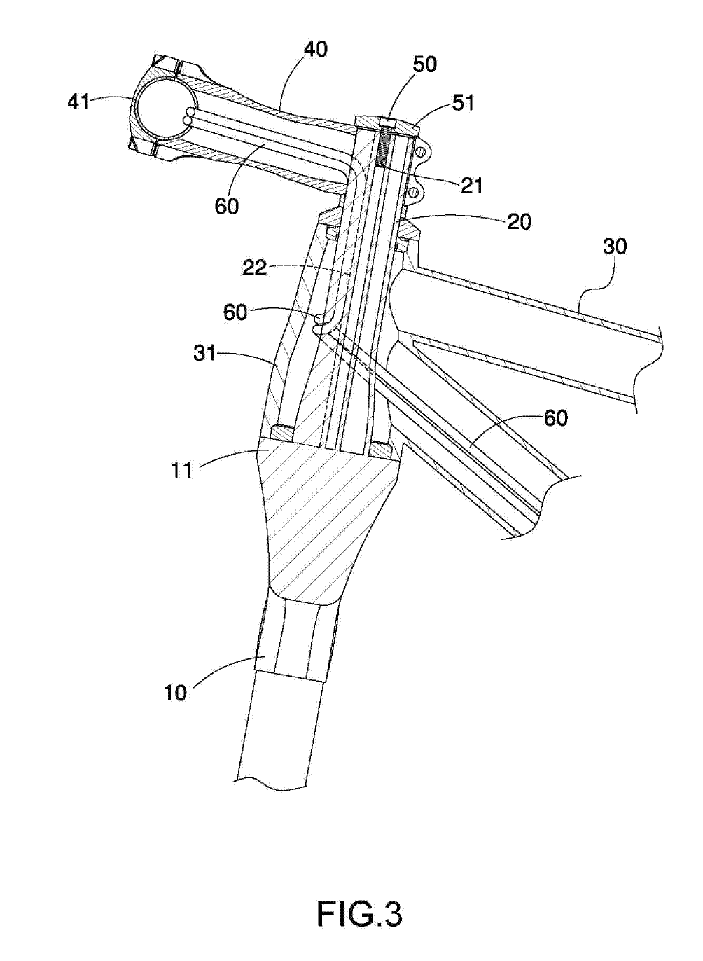

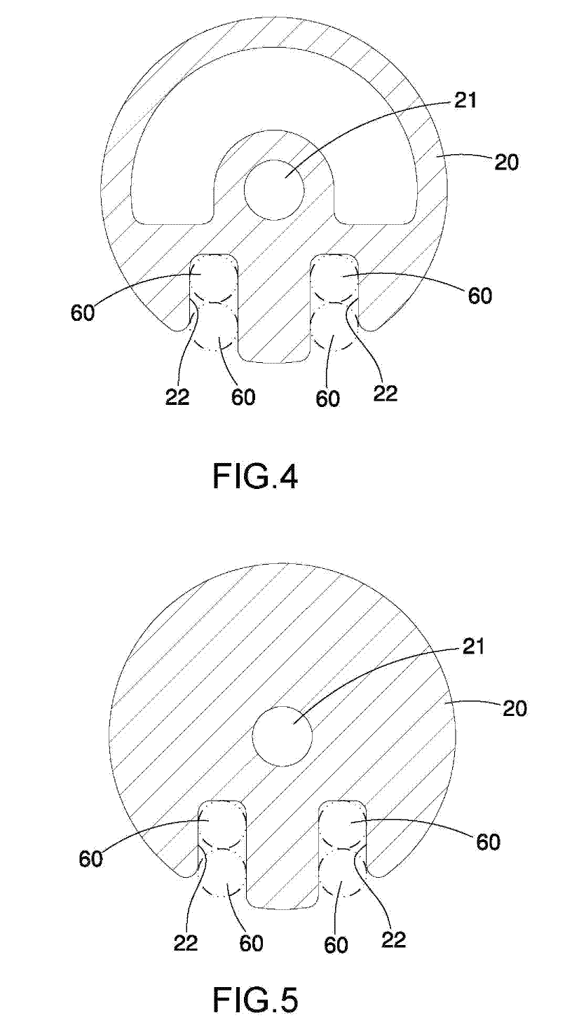

A steering tube 20 is connected to the top of the support 11 by its lower end. The steering tube 20 rotatably extends through a head tube 31 of a bicycle frame 30. The top end of the steering tube 20 extends beyond the head tube 31 and a bicycle stem 40 is connected to the top end of the steering tube 20. The support 11 has a threaded hole 21 defined in the top thereof, and a bolt 50 extends through a cap 51 and is threadedly connected to the threaded hole 21. The steering tube 20 has at least one groove 22 defined axially in the outer surface thereof. The at least one groove 22 includes an open top defined in the top of the steering tube 20. The at least one groove 22 receives at least one control cable 60 therein. In this embodiment, the steering tube 20 is a hollow tube which is an aluminum product and is made by way of extruding. As shown in FIG. 4, there are two grooves 22 in the steering tube 20 and each groove 22 receives one control cable 60.

As shown in FIG. 3, the control cables 60 extend through the handlebar stem 40 via the handlebar 41, and then extend through the rear end of the handlebar stem 40 and enter into the two grooves 22. The control cables 60 received in the two grooves 22 are hidden in the head tube 31 and then extend through the bicycle frame 30 and reach the desired positions.

As shown in FIG. 5, the steering tube 20 is a solid tube.

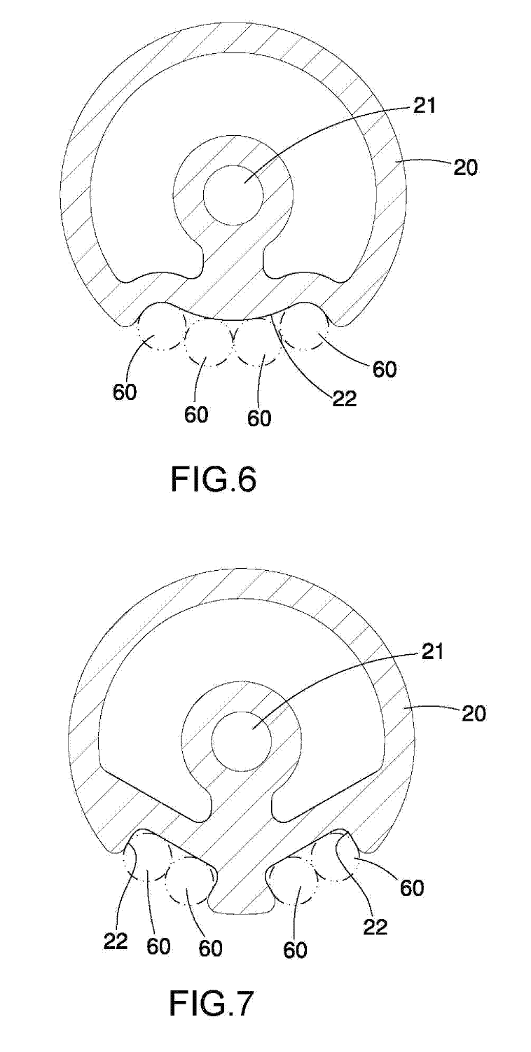

As shown in FIG. 6, the steering tube 20 includes one groove 22 in which four control cables 60 are received.

As shown in FIG. 7, the steering tube 20 includes two grooves 22, and each groove 22 receives two control cables 60 therein.

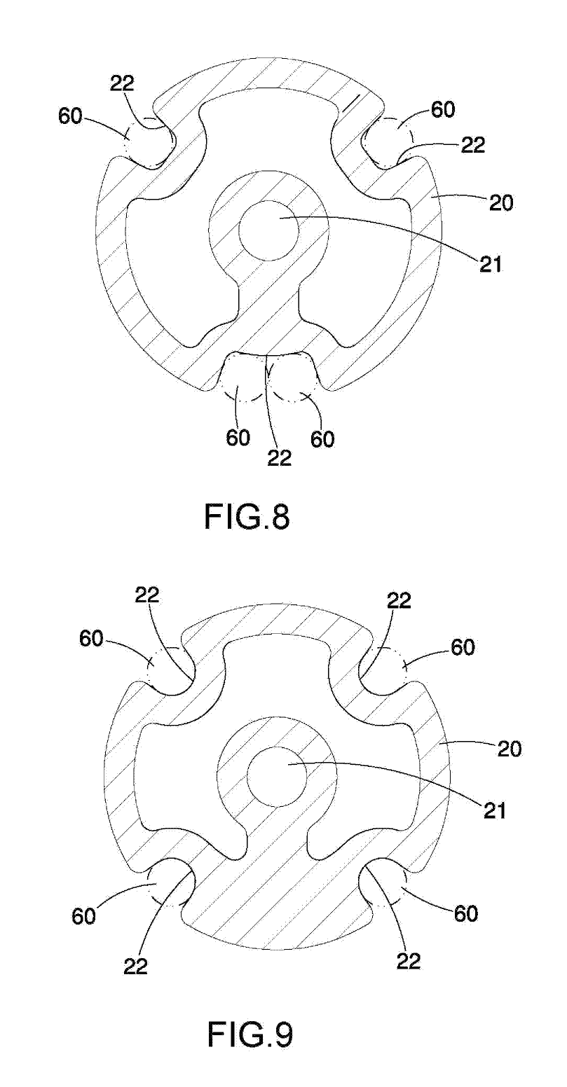

As shown in FIG. 8, the steering tube 20 includes three grooves 22, and one of the three grooves 22 receives two control cables 60 therein, and the rest of the two grooves 22 each receive one control cable 60 therein.

As shown in FIG. 9, the steering tube 20 includes four grooves 22, and each groove 22 receives one control cable 60 therein.

In the above mentioned embodiments, the shape of the grooves 22 can be made according to needs. The size of each groove 22 may be made to receive one, two, three, four or even more control cables 60.

The present invention provides at least one groove 22 defined in the outer surface of the steering tube 20 to receive at least one control cable 60 therein, such that the steering tube 20 is installed in the head tube 31 and the control cables 60 are hidden. The existed structure of the bicycle frame 30 and handlebar stem 40 does not need to be changed, and no extra weight or volume is increased. The manufacturing cost is saved. Especially, the aesthetic purposes of the bicycles are maintained by hiding the control cables 60.

While we have shown and described the embodiment in accordance with the present invention, it should be clear to those skilled in the art that further embodiments may be made without departing from the scope of the present invention.

What is claimed is:

1. A bicycle front fork comprising:
two extension tubes connected to each other at two respective top ends thereof;
a steering tube connected to a position where the two respective top ends of the two extension tubes are connected, the steering tube having at least one groove defined axially in an outer surface thereof, the at least one groove adapted to receive at least one control cable therein.

2. The bicycle front fork as claimed in claim 1, wherein a support is formed at the position where the two respective top ends of the two extension tubes are connected, a lower end of the steering tube is connected to a top of the support.

3. The bicycle front fork as claimed in claim 2, wherein the support has a threaded hole defined in the top thereof, a bolt is threadedly connected to the threaded hole.

4. The bicycle front fork as claimed in claim 2, wherein the at least one groove includes an open top defined in a top of the steering tube.

5. The bicycle front fork as claimed in claim 3, wherein the at least one groove includes an open top defined in a top of the steering tube.

6. The bicycle front fork as claimed in claim 4, wherein the steering tube is a hollow tube.

7. The bicycle front fork as claimed in claim 5, wherein the steering tube is a hollow tube.

8. The bicycle front fork as claimed in claim 4, wherein the steering tube is a solid tube.

9. The bicycle front fork as claimed in claim 5, wherein the steering tube is a solid tube.
